(19) United States
(12) Patent Application Publication
(10) Pub. No.: US 2024/0257819 A1
(43) Pub. Date: Aug. 1, 2024

(54) VOICE AUDIO COMPRESSION USING NEURAL NETWORKS

(71) Applicant: Adobe Inc., San Jose, CA (US)

(72) Inventors: Tiberiu BOROS, Bucharest (RO); Stefan Daniel DUMITRESCU, Bucharest (RO); Andrei COTAIE, Bucharest (RO); Joseph DAVIDSON, Farmington, UT (US); Alexandru Constantin CALISTRU, Magurele (RO); Ionut Daniel BARBU, Bucharest (RO)

(73) Assignee: Adobe Inc., San Jose, CA (US)

(21) Appl. No.: 18/163,170

(22) Filed: Feb. 1, 2023

(51) Int. Cl. G10L 19/038; G10L 25/18; G10L 25/30; G10L 25/90

(52) U.S. Cl. CPC G10L 19/038; G10L 25/18; G10L 25/30; G10L 25/90; G10L 2019/0001

(57) ABSTRACT

Embodiments are disclosed for training an audio processing system to perform high-quality speech audio encoding and decoding using neural networks. In particular, in one or more embodiments, the disclosed systems and methods comprise receiving an audio sequence, the audio sequence including speech audio, generating pitch data representing detected pitch within the audio sequence, passing the audio sequence through an audio encoder to generate a vector representation of the audio sequence, generating, by a vector quantizer, an encoded vector representation of the audio sequence using the vector representation of the audio sequence and a codebook of discrete vectors, and reconstructing, by an audio decoder, the audio sequence using the pitch data and the encoded vector representation of the audio sequence.

### BACKGROUND

Audio and video files are common types of media files that are transmitted, streamed, etc., across various communications channels, including the internet. High quality audio requires large storage capacity and high bandwidth, particularly for online on-demand services. Audio codecs can be used to encode or compress digital audio signals to reduce the bitrate of an audio file with the objective of representing high-fidelity audio signals with a minimum number of bits while retaining quality. Compressing audio files reduces the storage space needed to store audio files and the bandwidth required for transmission of the stored audio file.

### SUMMARY

Introduced here are techniques/technologies that allow an audio processing system to train an audio codec to encode (compress) and decode (reconstruct) a speech audio sequence using neural networks. The audio codec is trained to compress speech audio sequences at a low bitrate (e.g., 0.672 kbps for a 22 kHz voice stream) while maintaining high audio quality.

In particular, in one or more embodiments, as part of a training process, an audio processing system receives an audio sequence that includes speech audio (e.g., a presentation, speech, monologue, etc.). Using a pitch detection algorithm pitch data representing the detected pitch of the speaker within the speech audio is generated. The speech audio is also passed through an audio encoder to generate a vector representation of the speech audio (e.g., feature vectors). For example, the speech audio can be represented by a plurality of n-dimensional vectors of numerical features that represent the speech audio. The audio processing system further uses a vector quantizer to generate an encoded vector representation of the audio sequence using the generated feature vectors and a codebook of discrete vectors. An audio decoder can then reconstruct the audio sequence using the pitch data and the encoded vector representation of the audio sequence, and the audio processing system can be trained based on determining the loss between the original audio sequence and the reconstructed audio sequence.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of training machine learning models to perform speech audio encoding and decoding in accordance with one or more embodiments;

FIG. 2 illustrates a diagram of a process of training machine learning models to generate pitch data from speech audio sequences in accordance with one or more embodiments;

FIG. 3 illustrates a diagram of a process of encoding an audio sequence using neural networks in accordance with one or more embodiments;

FIG. 4 illustrates a diagram of a process of decoding an encoded audio sequence using neural networks in accordance with one or more embodiments;

FIG. 5 illustrates a schematic diagram of an audio processing system in accordance with one or more embodiments;

FIG. 6 illustrates a flowchart of a series of acts in a method of training an audio processing system to perform high-quality speech audio encoding and decoding using neural networks in accordance with one or more embodiments;

FIG. 7 illustrates a schematic diagram of an exemplary environment in which the audio processing system can operate in accordance with one or more embodiments; and

FIG. 8 illustrates a block diagram of an exemplary computing device in accordance with one or more embodiments.

### DETAILED DESCRIPTION

One or more embodiments of the present disclosure include an audio processing system that trains an encoder network to perform speech audio compression. Codecs (e.g., coder/decoders) are used to encode data (e.g., prior to transmission or storage) and decode data (e.g., upon receipt, retrieval from storage, etc.) for playback, display, etc. There are a number of uses for codecs, such as applying encryption, compression, etc. to data. One common use of audio codecs is to compress audio content to be stored and/or transmitted over one or more networks more economically. Likewise, the audio codes are used at playback time to obtain the audio data back in a format that can be played via a playback device. Different codecs implement different encoding/decoding techniques and provide different levels of performance. Some codecs use lossless compression so that all of the original data is retained when uncompressed, while other codecs use lossy compression that reduces file sizes by eliminating some of the original data (e.g., redundant data). However, traditional codecs have reached their maximum potential and are unable to go below current bitrate levels without resulting in degradation of the audio quality.

Some existing solutions have introduced neural networks to expand the capabilities of codecs. For example, some existing solutions use neural networks with a residual vector quantizer that use multiple vector quantizer layers with a large vector codebook (e.g., 218 vectors). However, such solutions are directed more toward learning quantization and not coherent symbolic representations for speech. Further, because these solutions use residual vector quantization with multiple layers and utilizes a large vector codebook, while they can produce high quality audio, they also have less efficient compression (e.g., over 3 kbps) and thus require additional computing and storage resources. Further, these solutions capture both the pitch (e.g., fundamental frequency) and the symbolic representation (e.g., phonemes) of speech through residual vector quantization, which also requires. Capturing both pitch and the symbolic representation via vector quantization requires a large vector codebook. Other solutions used for voice transfer (from one speaker to another) rely on continuous vector representations generated by the neural network. However, these solutions are unsuitable for compression, because, in some cases, they require higher bandwidth than simple compression solutions, while produce results with lower quality.

Existing audio compression solutions have limitations and drawbacks, as they can be resource-intensive, while producing inadequate or insufficient results. To address these and other issues, embodiments train neural networks used in an improved audio codec that compresses speech audio sequences at a low bitrate while maintaining high quality upon decoding. For example, to train the encoder and decoder of the audio codec, training speech audio sequences are passed through an audio processing system. A neural network generates feature vectors that represent the training speech audio sequence. Through vector quantization, an audio encoder encodes each feature vector of the training speech audio sequence by identifying a vector from a finite set of vectors (e.g., a vector codebook) that most closely matches the feature vector and assigns its index value in place of the feature vector. Serially, or in parallel, a pitch extraction algorithm is used to extract pitch data from the training speech audio sequence. The pitch data captures the fundamental frequency of the speaker in the training speech audio sequences. A decoder then reconstructs the training speech audio sequence using the pitch data and the encoded feature vectors. Losses are calculated and then backpropagated to further train the decoder.

By determining the pitch data for speech audio sequences and providing the pitch data generated for to the decoder, while using vector quantization to encode the symbolic representation for speech audio sequences, embodiments train a neural networks to reproduce input speech audio sequences in high quality while using less computing and storage resources. Separating the pitch of the speech from the symbolic representation of the speech allows the encoder to encode the symbolic representation of the speech using a smaller vector codebook. For example, embodiments can train an audio codec to compress speech audio at lower bitrates with higher quality (e.g., 0.672 kbps for a 22 kHz voice stream) when compared to other audio codecs.

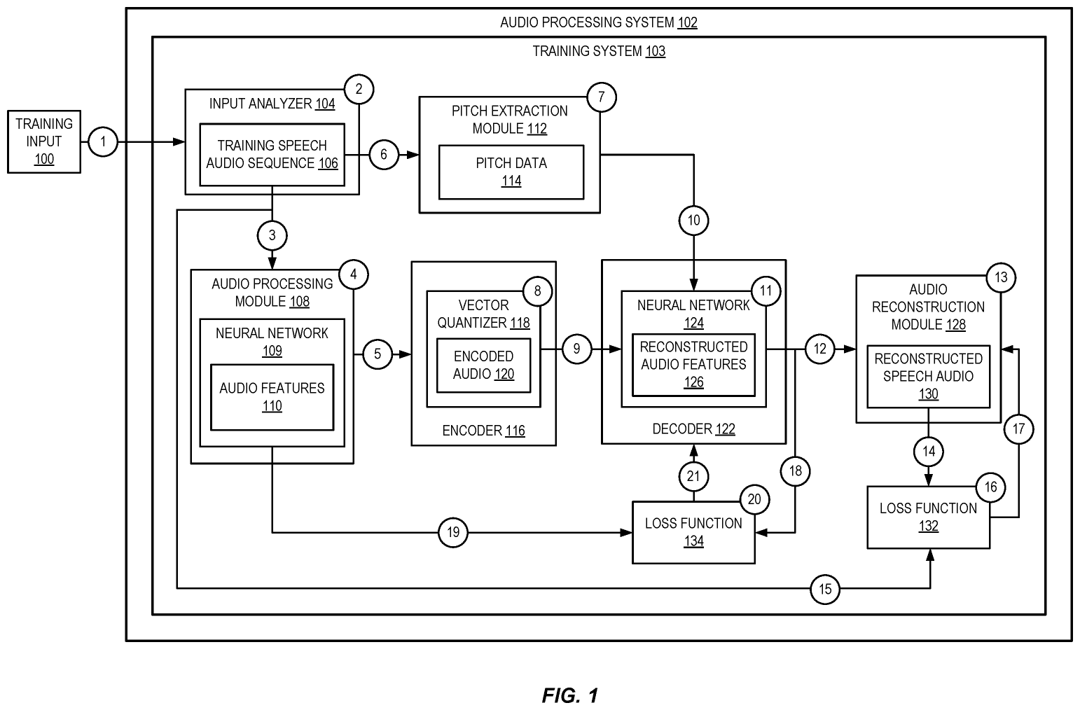

FIG. 1 illustrates a diagram of a process of training machine learning models to perform speech audio encoding and decoding in accordance with one or more embodiments. In one or more embodiments, a training system 103 is configured to train a neural network (e.g., in decoder 122) to generate reconstructed audio features using encoded audio (e.g., encoded audio 120) and pitch data (e.g., pitch data 114) based on training inputs. In some embodiments, the training system 103 is a part of an audio processing system 102. In other embodiments, the training system 103 can be a standalone system, or part of another system, and deployed to the audio processing system 102. For example, the training system 103 may be implemented as a separate system implemented on electronic devices separate from the electronic devices implementing audio processing system 102. As shown in FIG. 1, the training system 103 receives a training input 100, as shown at numeral 1. For example, the audio processing system 102 receives the training input 100 from a user via a computing device or from a memory or storage location. In one or more embodiments, the training input 100 includes at least a training speech audio sequence (e.g., training speech audio sequence 106). The training input 100 can include multiple training speech audio sequences that can be fed to the training system 103 in parallel or in series.

As illustrated in FIG. 1, the audio processing system 102 includes an input analyzer 104 that receives the training input 100. In some embodiments, the input analyzer 104 analyzes the training input 100, as shown at numeral 2. In some embodiments, the input analyzer 104 analyzes the training input 100 to identify training speech audio sequence 106.

After the input analyzer 104 analyzes the training input 100 to identify training speech audio sequence 106, the training speech audio sequence 106 is sent to an audio processing module 108, as shown at numeral 3. In one or more other embodiments, the input analyzer 104 optionally stores the training speech audio sequence 106 in a memory or storage location for later access.

In one or more embodiments, neural network 109 of the audio processing module 108 is configured to generate audio features 110 from the training speech audio sequence 106, at numeral 4. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In one or more embodiments, the neural network 109 is a nine-layer dilated convolutional neural network (CNN). In one or more embodiments, the neural network 109 is used to “look” at a 512 timestep window.

The audio processing module 108 can be a Mel extraction process that generates the audio features 110 by converting the training speech audio sequence 106 from the time domain to the frequency domain. In some embodiments, the audio features 110 are feature vectors that are n-dimensional vectors of numerical features that represent the training speech audio sequence 106.

The audio processing module 108 can then downsample the vector representation of the audio sequence. In one or more embodiments, the audio features 110 are downsampled, by discarding a subset of the frames (e.g., every odd or even frame, every third frame, etc.), to reduce the information quantity. Speech can be regarded as locally stationary because there is a limit to how rapid a person can articulate. As such, a small, isolated (adjoining) portion of a speech signal can be considered as a stationary signal on its own (ranging from 10 ms to 25 ms) Because the audio signal is quasi-stationary, discarding every second frame reduces bandwidth by half while retaining the ability to identify phonetic features (e.g., vowels, etc.). For example, given a training speech audio sequence 106 of 16 kHz per second, the Mel extraction process generates a feature vector for every 12.5 ms (or approximately 80 frames per second). A downsample of every other frame results in 40 frames per second, or 40 feature vectors per second in the audio features 110. In other embodiments, the Mel extraction process extracts frames at different rates that are then downsampled similarly (e.g., a feature vector for every 16 ms, or 62 frames, that can be downsampled to 31.25 frames per second). Given a training speech audio sequence 106 of 50 seconds, audio features 110 will include 2000 feature vectors. After the audio processing module 108 generates the audio features 110, the audio features 110 are sent to an encoder 116, as shown at numeral 5.

In one or more embodiments, the input analyzer 104 also sends the training speech audio sequence 106 to a pitch extraction module 112, as shown at numeral 6. The pitch extraction module 112 can include a pitch detection algorithm that generates pitch data 114 representing the detected pitch (e.g., fundamental frequency) of the training speech audio sequence 106. In one or more embodiments, RAPT (Robust Algorithm for Pitch Tracking) is used to derive the pitch data 114 from the training speech audio sequence 106. As RAPT is most efficient for clean speech audio, noise can be added to the training speech audio sequence 106 to train the neural network 109 to more accurately predict the pitch from speech audio sequences that may contain noise (e.g., background sounds, echoes, etc.). In one or more embodiments, the pitch data 114 is also downsampled in a similar manner as to the feature vectors representing the audio features 110 of the training speech audio sequence 106. As the fundamental frequency is less than 500 Hz and given 80 frames per second, a downsampling of every other frame results in 40 frames of pitch data 114 for each second of the training speech audio sequence 106.

In one or more embodiments, the encoder 116 includes a vector quantizer 118 to generate encoded audio 120 from the audio features 110 through a vector quantization process, at numeral 8. In one or more embodiments, the vector quantizer 118 is a Vector Quantized Variational Autoencoder (VQ-VAE) that uses vector quantization to obtain a discrete latent representation of the audio features 110. The vector quantization process uses a codebook that includes a finite set of vectors to encode or compress the audio features 110 into an encoded representation. This allows the audio features 110, which can include an indefinite and large number of values, to be represented and transmitted using a finite number of bits. In one or more embodiments, the vector quantizer 118 uses a codebook that includes 256 vectors/tokens of size 64, which can be represented by an octet (e.g., 2⁸ bits). In one or more embodiments, for each feature vector in audio features 110, the vector quantizer 118 identifies a vector from the codebook that most closely matches the feature vector, and associates an index value (e.g., 0 to 255 in bit form) with the feature vector corresponding to the vector from the codebook. Continuing the example above, each feature vector of the 2000 feature vectors representing the training speech audio sequence 106 is associated with an octet, where each octet represents, or indicates (in bit form), one of the vectors from the codebook that most closely matches the corresponding feature vector.

After the vector quantizer 118 generates the encoded audio 120, the encoded audio 120 is sent to a decoder 122, as shown at numeral 9. The decoder 122 can also be referred to as an upsampler. In one or more embodiments the decoder 122 also receives the pitch data 114 generated by the pitch extraction module 112, as shown at numeral 10. While the speaking style, and, at least partially the prosody, of the training speech audio sequence 106 is encoded using the codebook, the pitch data 114 is provided to the decoder 122 to allow the decoder 122 to be able to accurately reproduce speech. Combined, each frame of the training speech audio sequence 106 can be associated with an octet from the encoded audio 120 and an octet from the pitch data 114. In one or more embodiments, the decoder 122 includes a neural network 124 that uses the encoded audio 120 and the pitch data 114 to generate reconstructed audio features 126, at numeral 11.

In one or more embodiments, the neural network 124 is a recurrent neural network (RNN). In some embodiments, the neural network 124 is a two-layer long short-term memory (LSTM) neural network of size 256, that reconstructs the spectral representation of training speech audio sequence 106 (e.g., audio features 110). In one or more embodiments, the reconstructed audio features 126 generated by passing the encoded audio 120 and the pitch data 114 through the neural network 124 are feature vectors that are n-dimensional vectors of numerical features that represent a reconstruction of the training speech audio sequence 106 in the frequency-domain. After the decoder 122 generates the reconstructed audio features 126, the reconstructed audio features 126 are sent to an audio reconstruction module 128, as shown at numeral 12.

In one or more embodiments, the audio reconstruction module 128 generates reconstructed speech audio 130 using the reconstructed audio features 126, at numeral 13. The audio reconstruction module 128 can include a generator and a discriminator. In some embodiments, the audio reconstruction module 128 is a Mel Generative Adversarial Network (MelGAN) that generates raw audio in the time-domain from the reconstructed audio features 126 in the frequency-domain. In one or more embodiments, the generator includes multiple stacks of upsampling layers and residual stacks, takes as input a Mel-spectrogram (e.g., reconstructed audio features 126) and generates raw audio (e.g., reconstructed speech audio 130) as an output signal, where the raw audio is a 1D signal. In one or more embodiments, the discriminator receives the reconstructed speech audio 130 and the original 1D signal (e.g., training speech audio sequence 106) as input. In one or more embodiments, the discriminator uses a multi scale architecture that employs three discriminator networks that see the raw audio generated by the generator at different resolutions. In such embodiments, the first discriminator works with the output signal, the second discriminator uses the output signal downsampled by two, and the third discriminator uses the output signal downsampled by three. In some embodiments, the generator is trained using adversary loss with the discriminator and “feature-map” loss, minimizing the error of the internal discriminator representations (not the output) for both real and generated audio. Other embodiments can use other generators and discriminators. In one or more embodiments, the generator is trained to confuse the discriminator by generating more-natural sounding audio. In one or more embodiment, the discriminator is trained using both the frames of the output signal (e.g., the artificial or encoded frames) and frames of the original input signal (e.g., natural frames).

In one or more embodiments, components of the audio processing system 102 can be trained using one or more loss functions. Although described in the manner depicted in FIG. 1, the loss functions can be performed in different orders and at different times. For example, one or more losses can be determined in parallel with one or more of the steps described above with respect to FIG. 1.

In some embodiments, after the audio reconstruction module 128 generates the reconstructed speech audio 130, the reconstructed speech audio 130 is sent to a loss function 132, as shown at numeral 14. The training speech audio sequence 106 is also sent to the loss function 132, as shown at numeral 15. Using the reconstructed speech audio 130 and the training speech audio sequence 106, the loss function 132 calculates a loss, at numeral 16. The calculated loss can then be backpropagated to train the audio reconstruction module 128, as shown at numeral 17. In one or more embodiments, the loss calculated at numeral 16 can also be backpropagated to train the encoder 116.

Similarly, the reconstructed audio features 126 that is output by the decoder 122 can be sent to a loss function 134, as shown at numeral 18. The audio features 110 are also sent to the loss function 134, as shown at numeral 19. Using the audio features 110 and the reconstructed audio features 126, the loss function 134 can calculate a loss, at numeral 20. The calculated loss can then be backpropagated to train the neural network 124 of the decoder 122, as shown at numeral 21. In one or more embodiments, the loss calculated at numeral 20 can also be backpropagated to train the encoder 116.

In one or more embodiments, a loss function is also used to train neural network 109 to generate pitch data. In such embodiments, a mean-squared error loss is used using the pitch data 114 generated by the pitch extraction module 112 and pitch data generated by the neural network 109. The loss can calculated loss can then be backpropagated to train the neural network 109.

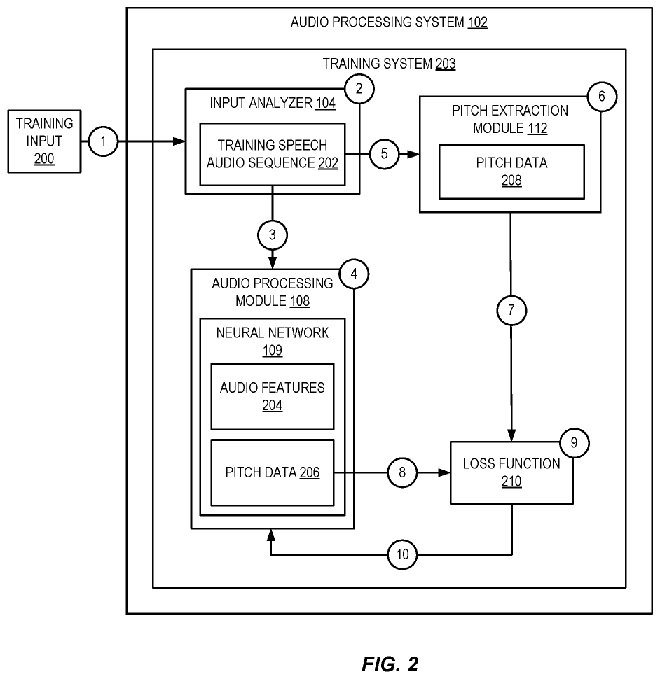

FIG. 2 illustrates a diagram of a process of training machine learning models to generate pitch data from speech audio sequences in accordance with one or more embodiments. In one or more embodiments, the neural network 109 of the audio processing module 108 can be trained to generate the pitch data 114 from the training speech audio sequence 202, instead of using the pitch extraction module 112 to extract the pitch data 114, as depicted in FIG. 1. In one or more embodiments, a training system 203 is configured to train a neural network (e.g., in neural network 109) to generate pitch data for input speech audio. In some embodiments, the training system 203 is a part of an audio processing system 102. In other embodiments, the training system 203 can be a standalone system, or part of another system, and deployed to the audio processing system 102. For example, the training system 203 may be implemented as a separate system implemented on electronic devices separate from the electronic devices implementing audio processing system 102. As shown in FIG. 2, the training system 203 receives a training input 200, as shown at numeral 1. For example, the training system 203 receives the training input 200 from a user via a computing device or from a memory or storage location. In one or more embodiments, the training input 200 includes at least a training speech audio sequence (e.g., training speech audio sequence 202). The training input 200 can include multiple training speech audio sequences that can be fed to the training system 203 in parallel or in series.

As illustrated in FIG. 2, the audio processing system 102 includes an input analyzer 104 that receives the training input 200. In some embodiments, the input analyzer 104 analyzes the training input 200, as shown at numeral 2. In some embodiments, the input analyzer 104 analyzes the training input 200 to identify training speech audio sequence 202.

After the input analyzer 104 analyzes the training input 200 to identify training speech audio sequence 202, the training speech audio sequence 202 is sent to an audio processing module 108, as shown at numeral 3. In one or more other embodiments, the input analyzer 104 optionally stores the training speech audio sequence 202 in a memory or storage location for later access.

In one or more embodiments, the neural network 109 of the audio processing module 108 is configured to generate audio features 204 from the training speech audio sequence 202, at numeral 4, as described with respect to FIG. 1. The neural network 109 can also be configured to generate pitch data 206. In such embodiments, for each frame, the neural network 109 outputs two scalars representing the pitch data 206: a first scalar is used for pitch (also called FO) and a second scalar for voiced/unvoiced decision. Regions of speech audio sequences with constant speech or silence are considered unvoiced. No pitch can be computed for such regions and the first scalar defaults to “0”. The voiced/unvoiced scalar is also “0” for these regions. For voiced portions of speech audio sequences, the first scalar takes a float value between “0” and “1” (which is later denormalized by multiplication with 500 Hz) and the second scalar value is set to “1.”

In one or more embodiments, the input analyzer 104 also sends the training speech audio sequence 202 to a pitch extraction module 112, as shown at numeral 5. The pitch extraction module 112 can include a pitch detection algorithm that generates pitch data 208 representing the detected pitch (e.g., fundamental frequency) of the training speech audio sequence 202. The pitch data 208 that is output by the pitch extraction module 112 can be sent to a loss function 210, as shown at numeral 7. The pitch data 206 generated by the neural network 109 is also sent to the loss function 210, as shown at numeral 8.

Using the pitch data 206 generated by the neural network 109 and the pitch data 208 extracted by the pitch extraction module 112, the loss function 210 can calculate a loss, at numeral 9. In one or more embodiments, no loss is inferred for the first scalar on unvoiced regions, given that pitch is not computable in those regions. The loss for the second scalar is computed over the entire training speech audio sequence 202. The calculated loss can then be backpropagated to train the neural network 109, as shown at numeral 10.

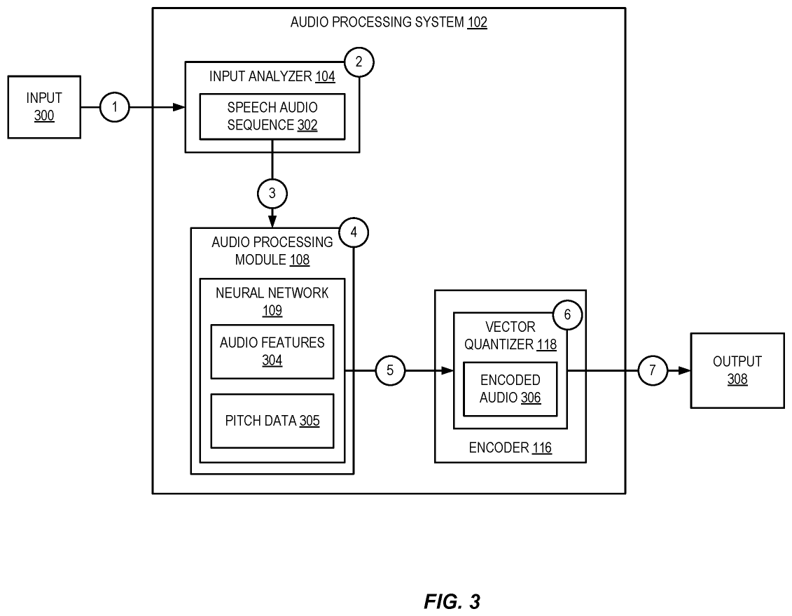

FIG. 3 illustrates a diagram of a process of encoding an audio sequence using neural networks in accordance with one or more embodiments. Once an encoder and decoder are trained (e.g., as described with respect to FIGS. 1 and 2), the encoder and decoder can be implemented on separate computing devices to allows for the transmission of high-quality speech audio over a network. As shown in FIG. 3, the audio processing system 102 receives an input 300, as shown at numeral 1. For example, the audio processing system 102 receives the input 300 from a user via a computing device or from a memory or storage location. In one or more embodiments, the input 300 includes at least a speech audio sequence (e.g., speech audio sequence 302).

As illustrated in FIG. 3, the audio processing system 102 includes an input analyzer 104 that receives the input 300. In some embodiments, the input analyzer 104 analyzes the input 300, as shown at numeral 2. In some embodiments, the input analyzer 104 analyzes the input 300 to identify speech audio sequence 302.

After the input analyzer 104 analyzes the input 300 to identify speech audio sequence 302, the speech audio sequence 302 is sent to an audio processing module 108, as shown at numeral 3. In one or more other embodiments, the input analyzer 104 optionally stores the speech audio sequence 302 in a memory or storage location for later access.

In one or more embodiments, the neural network 109 of the audio processing module 108 is configured to generate audio features 304 and pitch data 305 from the speech audio sequence 302, at numeral 4, as described with respect to FIGS. 1 and 2. In one or more embodiments, while the output for the second scalar is a float, it is converted to a binary value using a threshold of 0.5, where values below 0.5 are assigned a value of “0” and values equal to or greater than 0.5 are assigned a value of “1.” The second scalar is then multiplied with the pitch to mask its value.

After the audio processing module 108 generates the audio features 304, the audio features 304 are sent to an encoder 116, as shown at numeral 5. In one or more embodiments, the encoder 116 includes a vector quantizer 118 to generate encoded audio sequence 306 from the audio features 304 through a vector quantization process, at numeral 6, as described with re respect to FIG. 1. After the vector quantizer 118 generates the encoded audio sequence 306, the encoded audio sequence 306 can be sent as an output 308, as shown at numeral 7. In one or more embodiments, after the process described above in numerals 1-6, the output 308 is sent through a communications channel to the user device or computing device that will decode encoded audio sequence 306, to another computing device associated with the user or another user, or to another system or application. In one or more embodiments, the pitch data 305 is also sent through the communications channel in the output 308. The pitch data 305 can be sent as a single byte (e.g., clipped at 500 Hz and divided by two to obtain a value between 0 and 255) to reduce bandwidth usage.

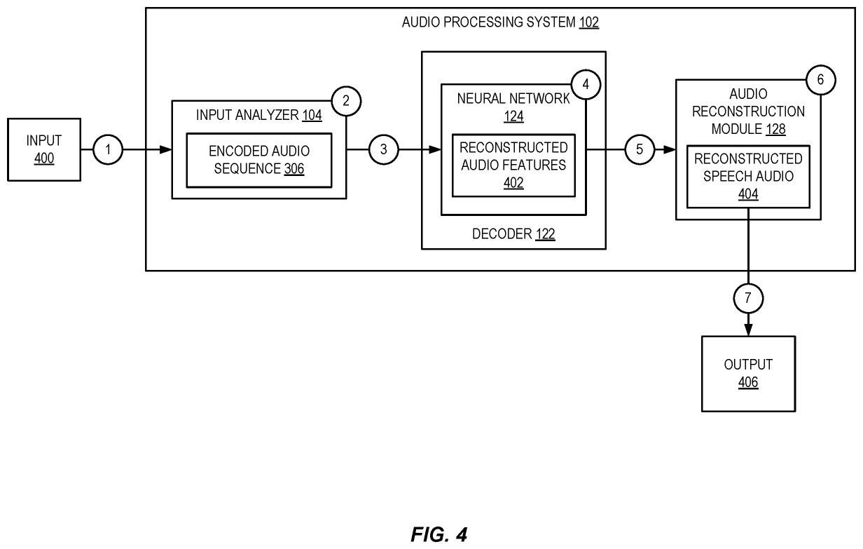

FIG. 4 illustrates a diagram of a process of decoding an encoded audio sequence using neural networks in accordance with one or more embodiments. As shown in FIG. 4, the audio processing system 102 receives an input 400, as shown at numeral 1. For example, the audio processing system 102 receives the input 400 from a user via a computing device or from a memory or storage location. In one or more embodiments, the input 400 includes at least an encoded audio sequence (e.g., encoded audio sequence 306 generated as described with respect to FIG. 3).

As illustrated in FIG. 4, the audio processing system 102 includes an input analyzer 104 that receives the input 400. In some embodiments, the input analyzer 104 analyzes the input 400, as shown at numeral 2. In some embodiments, the input analyzer 104 analyzes the input 400 to identify encoded audio sequence 306.

After the input analyzer 104 analyzes the input 400 to identify the encoded audio sequence 306, the encoded audio sequence 306 is sent to an audio processing module 108, as shown at numeral 3. In one or more other embodiments, the input analyzer 104 optionally stores the encoded audio sequence 306 in a memory or storage location for later access.

In one or more embodiments, the decoder 122 includes a neural network 124 that uses the encoded audio 120 and the codebook of vectors originally used to generate encoded audio 120 to generate reconstructed audio features 402, at numeral 4. In one or more embodiments, the neural network 124 is a recurrent neural network (RNN). In some embodiments, the neural network 124 is a two-layer long short-term memory (LSTM) neural network of size 256, that reconstructs the spectral representation of speech audio sequence 302. In one or more embodiments, the reconstructed audio features 402 generated by passing the encoded audio sequence 306 through the neural network 124 are feature vectors that are n-dimensional vectors of numerical features that represent a reconstruction of the speech audio sequence 302 in the frequency-domain. After the decoder 122 generates the reconstructed audio features 402, the reconstructed audio features 402 are sent to an audio reconstruction module 128, as shown at numeral 5.

In one or more embodiments, the audio reconstruction module 128 generates reconstructed speech audio 130 using the reconstructed audio features 126, at numeral 13. The audio reconstruction module 128 can include a generator and a discriminator. In some embodiments, the audio reconstruction module 128 is a Mel Generative Adversarial Network (MelGAN) that generates raw audio in the time-domain from the audio reconstruction module 128 in the frequency-domain.

After the audio reconstruction module 128 generates the reconstructed speech audio 404, the reconstructed speech audio 404 can be sent as an output 406, as shown at numeral 7. In one or more embodiments, after the process described above in numerals 1-6, the output 406 can be provided in a computing device associated with the user or another user, or to another system or application.

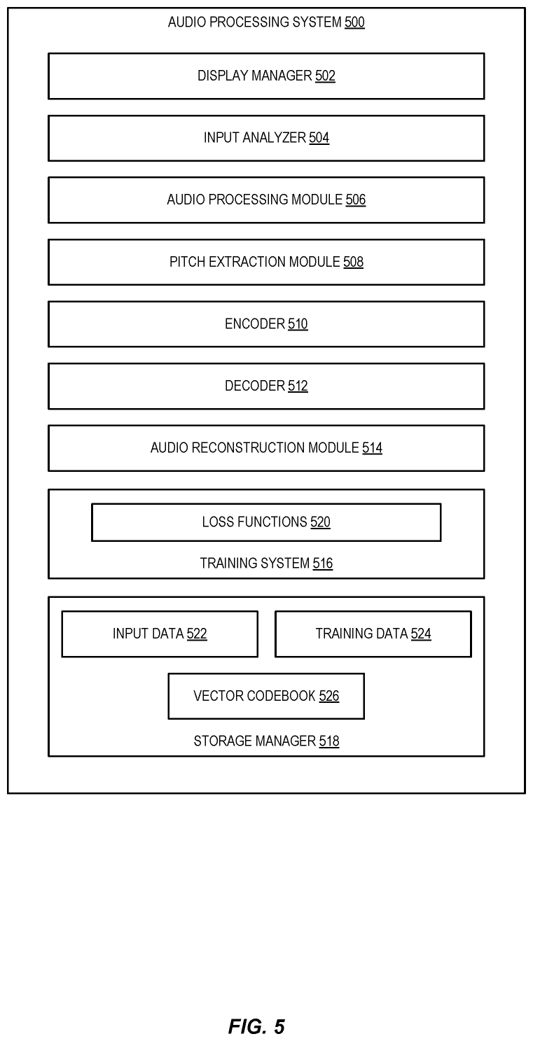

FIG. 5 illustrates a schematic diagram of an audio processing system (e.g., “audio processing system” described above) in accordance with one or more embodiments. As shown, the audio processing system 500 may include, but is not limited to, a display manager 502, an input analyzer 504, an audio processing module 506, a pitch extraction module 508, an encoder 510, a decoder 512, an audio reconstruction module 514, a training system 516, and a storage manager 518. As shown, the training system 516 include loss functions 520. The storage manager 518 includes input data 522, training data 524, and a vector codebook 526.

As illustrated in FIG. 5, the audio processing system 500 includes a display manager 502. In one or more embodiments, the display manager 502 identifies, provides, manages, and/or controls a user interface provided on a touch screen or other device. Examples of displays include interactive whiteboards, graphical user interfaces (or simply “user interfaces”) that allow a user to view and interact with content items, or other items capable of display on a touch screen. For example, the display manager 502 may identify, display, update, or otherwise provide various user interfaces that include one or more display elements in various layouts. In one or more embodiments, the display manager 502 can identify a display provided on a touch screen or other types of displays (e.g., including monitors, projectors, headsets, etc.) that may be interacted with using a variety of input devices. For example, a display may include a graphical user interface including one or more display elements capable of being interacted with via one or more touch gestures or other types of user inputs (e.g., using a stylus, a mouse, or other input devices). Display elements include, but are not limited to buttons, text boxes, menus, thumbnails, scroll bars, hyperlinks, etc.

As further illustrated in FIG. 5, the audio processing system 500 also includes an input analyzer 504. The input analyzer 504 analyzes an input received by the audio processing system 500 to identify audio sequences (e.g., speech audio sequences).

As further illustrated in FIG. 5, the audio processing system 500 also includes an audio processing module 506 configured to extract audio features, or feature vectors, from an input audio sequence (e.g., speech audio sequences and training speech audio sequences). The audio processing module 506 can be a Mel extraction process that generates audio features by converting the input audio sequence from the time domain to the frequency domain. In some embodiments, the audio features are feature vectors that are n-dimensional vectors of numerical features that represent the input audio sequence. The audio features are then passed through a neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In one or more embodiments, the neural network is a nine-layer dilated convolutional neural network (CNN). In one or more embodiments, the audio processing module 506 is further configured to downsample the vector representation of the audio sequence by discarding a subset of the frames (e.g., every odd or even frame, etc.).

As further illustrated in FIG. 5, the audio processing system 500 also includes a pitch extraction module 508 configured to generate pitch data from an input audio sequence. The pitch extraction module 508 can include a pitch detection algorithm that generates pitch data representing the detected pitch (e.g., fundamental frequency) of the input audio sequence. In one or more embodiments, RAPT (Robust Algorithm for Pitch Tracking) is used to derive the pitch data.

As further illustrated in FIG. 5, the audio processing system 500 also includes an encoder 510 configured to encode audio features representing an input audio sequence using a vector codebook. In one or more embodiments, the encoder 510 includes a vector quantizer to generate the encoded audio from the audio features through a vector quantization process. In one or more embodiments, the vector quantizer a Vector Quantized Variational Autoencoder (VQ-VAE) that uses vector quantization to obtain a discrete latent representation of the audio features. The vector quantization process uses a codebook that includes a finite set of vectors to encode or compress the audio features into an encoded representation to allow the audio features to be represented and transmitted using a finite number of bits. In one or more embodiments, the vector quantizer uses a codebook of 256 vectors/tokens of size 64, which can be represented by an octet (e.g., 2⁸ bits). For each feature vector, the vector quantizer identifies a vector from the codebook that most closely matches the feature vector, and associates an index value (e.g., 0 to 255 in bit form) with the feature vector corresponding to the vector from the codebook.

As further illustrated in FIG. 5, the audio processing system 500 also includes a decoder 512 configured to decode encoded audio using a vector codebook. During a training process, the decoder 512, or upsampler, processes encoded audio and corresponding pitch data through a neural network to generate reconstructed audio features that represent an input training audio sequence in the frequency domain. During inference, the decoder 512 processes encoded audio without pitch data to generate reconstructed audio features that represent an input audio sequence in the frequency domain. In one or more embodiments, the neural network is a two-layer long short-term memory (LSTM) neural network of size 256, that reconstructs the spectral representation of audio sequence using at least encoded audio.

As further illustrated in FIG. 5, the audio processing system 500 also includes an audio reconstruction module 514 configured to generate a reconstruction of the input audio sequence that was encoded using the reconstructed audio features. The audio reconstruction module 514 include a generator and a discriminator. In some embodiments, the audio reconstruction module 514 is a Mel Generative Adversarial Network (MelGAN) that generates raw audio in the time-domain from the reconstructed audio features in the frequency-domain. Other embodiments can use other generators and discriminators.

As further illustrated in FIG. 5, the audio processing system 500 includes training system 516 which is configured to teach, guide, tune, and/or train one or more neural networks. In particular, the training system 516 trains pitch extraction module 508, decoder 512, and audio reconstruction module 514, based on training data.

As further illustrated in FIG. 5, the storage manager 518 includes input data 522, training data 524, and a vector codebook 526. In particular, the input data 522 may include an input audio sequence received by the audio processing system 500. In one or more embodiments, the training data 524 may include audio sequences (e.g., speech audio sequences) that can be used during a training process of the audio processing system 500 to train one or more neural networks. The vector codebook 526 stores audio feature vectors and an index indicating index values associated with each audio feature vector. In one or more embodiments, the vector codebook 526 stores information for 256 (or 2⁸) audio feature vectors corresponding to phonemes.

Each of the components 502-518 of the audio processing system 500 and their corresponding elements (as shown in FIG. 5) may be in communication with one another using any suitable communication technologies. It will be recognized that although components 502-518 and their corresponding elements are shown to be separate in FIG. 5, any of components 502-518 and their corresponding elements may be combined into fewer components, such as into a single facility or module, divided into more components, or configured into different components as may serve a particular embodiment.

The components 502-518 and their corresponding elements can comprise software, hardware, or both. For example, the components 502-518 and their corresponding elements can comprise one or more instructions stored on a computer-readable storage medium and executable by processors of one or more computing devices. When executed by the one or more processors, the computer-executable instructions of the audio processing system 500 can cause a client device and/or a server device to perform the methods described herein. Alternatively, the components 502-518 and their corresponding elements can comprise hardware, such as a special purpose processing device to perform a certain function or group of functions. Additionally, the components 502-518 and their corresponding elements can comprise a combination of computer-executable instructions and hardware.

Furthermore, the components 502-518 of the audio processing system 500 may, for example, be implemented as one or more stand-alone applications, as one or more modules of an application, as one or more plug-ins, as one or more library functions or functions that may be called by other applications, and/or as a cloud-computing model. Thus, the components 502-518 of the audio processing system 500 may be implemented as a stand-alone application, such as a desktop or mobile application. Furthermore, the components 502-518 of the audio processing system 500 may be implemented as one or more web-based applications hosted on a remote server. Alternatively, or additionally, the components of the audio processing system 500 may be implemented in a suit of mobile device applications or “apps.”

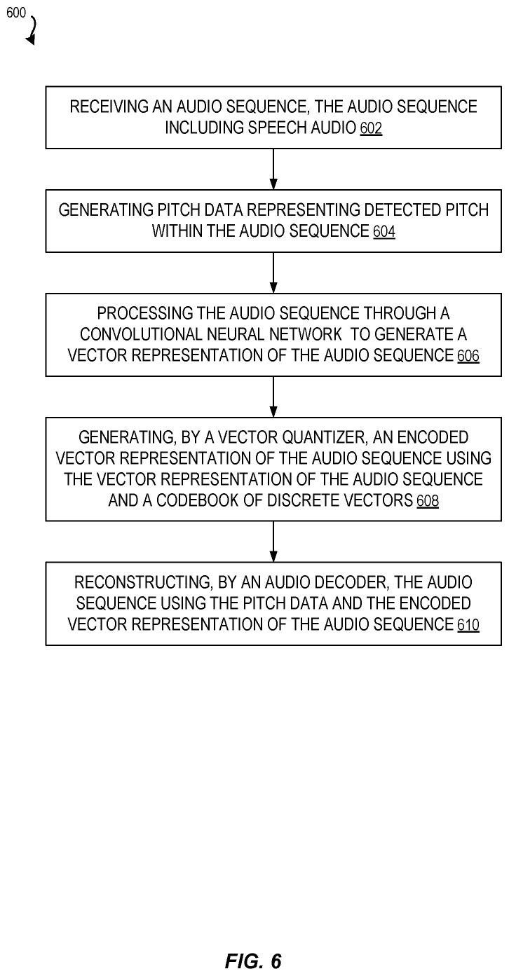

FIGS. 1-5, the corresponding text, and the examples, provide a number of different systems and devices that train an encoder and a decoder of an audio processing system to perform high-quality speech audio encoding and decoding using neural networks. In addition to the foregoing, embodiments can also be described in terms of flowcharts comprising acts and steps in a method for accomplishing a particular result. For example, FIG. 6 illustrates a flowchart of an exemplary method in accordance with one or more embodiments. The method described in relation to FIG. 6 may be performed with less or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of a series of acts in a method of training an audio processing system to perform high-quality speech audio encoding and decoding using neural networks in accordance with one or more embodiments. In one or more embodiments, the method 600 is performed in a digital medium environment that includes the audio processing system 500. The method 600 is intended to be illustrative of one or more methods in accordance with the present disclosure and is not intended to limit potential embodiments. Alternative embodiments can include additional, fewer, or different steps than those articulated in FIG. 6.

As shown in FIG. 6, the method 600 includes an act 602 of receiving an audio sequence, the audio sequence including speech audio. In one or more embodiments, the audio sequence is a training speech audio for training an encoder and decoder of an audio processing system to perform high-quality audio compression and reconstruction using neural networks. In one or more embodiments, the audio processing system receives the audio sequence from a user (e.g., via a computing device). In one or more embodiments, the user may select the tr audio sequence in an application, or the user may submit the audio sequence to a web service or an application configured to receive inputs. The audio sequence can also be a portion selected from a longer audio sequence. For example, after providing the audio sequence to the application, the application can provide an interface to enable the user to select a portion of the longer audio sequence.

As shown in FIG. 6, the method 600 also includes an act 604 of generating pitch data representing detected pitch within the audio sequence. In one or more embodiments, the audio processing system includes a pitch extraction module. The pitch extraction module can include a pitch detection algorithm that generates initial pitch data representing the detected pitch (e.g., fundamental frequency) of the audio sequence. In one or more embodiments, RAPT (Robust Algorithm for Pitch Tracking) is used to derive the initial pitch data. In one or more embodiments, the initial pitch data is downsampled.

As shown in FIG. 6, the method 600 also includes an act 606 of processing the audio sequence through a convolutional neural network (CNN) to generate a vector representation of the audio sequence. In one or more embodiments, the CNN is a nine-layer dilated CNN. In one or more embodiments, the CNN is part of a Mel extractor that generates the vector representation of the audio sequence (e.g., audio features) by converting the audio sequence from the time domain to the frequency domain. In some embodiments, the audio features are feature vectors that are n-dimensional vectors of numerical features that represent the audio sequence. The audio features can then be passed to an encoder.

In one or more alternative embodiments, the convolutional neural network can be bypassed and the audio sequence in its raw form is sent to the encoder.

As shown in FIG. 6, the method 600 also includes an act 608 of generating, by a vector quantizer, an encoded vector representation of the audio sequence using the vector representation of the audio sequence and a codebook of discrete vectors. In one or more embodiments, the vector quantizer is a Vector Quantized Variational Autoencoder (VQ-VAE) that uses vector quantization to obtain a discrete latent representation of the audio features. The vector quantization process uses a codebook that includes a finite set of vectors, or coding vectors, to encode or compress the audio features into the encoded vector representation. The vector quantization process allows the audio vectors, which can include an indefinite and large number of values, to be represented and transmitted using a finite number of bits. In one or more embodiments, the vector quantizer uses a codebook that includes 256 vectors/tokens of size 64, which can be represented by an octet (e.g., 2⁸ bits). In one or more embodiments, for each feature vector of the vector representation of the audio sequence, the vector quantizer identifies a vector from the codebook that most closely matches and associates an index value (e.g., 0 to 255 in bit form) with the feature vector corresponding to the vector from the codebook.

As shown in FIG. 6, the method 600 also includes an act 610 of reconstructing, by an audio decoder, the audio sequence using the pitch data and the encoded vector representation of the audio sequence. After the vector quantizer generates the encoded vector representation of the audio sequence, the encoded vector representation is sent to a decoder or upsampler. In one or more embodiments the decoder also receives the pitch data generated by the pitch extraction module, described in act 604. While the speaking style and, at least partially, the prosody, of the training speech audio sequence is encoded using the codebook, the pitch data is provided to the decoder (e.g., in parallel to the encoding of the training speech audio sequence) to allow the decoder to be able to accurately reproduce speech. Combined, each frame of the audio sequence can be associated with an octet from the encoded audio and an octet from the pitch data. In one or more embodiments, the decoder includes a recurrent neural network that uses the encoded vector representation and the pitch data to generate reconstructed audio features (e.g., reconstructed audio feature vectors).

In one or more embodiments, a loss between the reconstructed audio features and the audio features generated in act 606 can be computed and backpropagated as part of training the decoder.

In one or more embodiments, an audio reconstruction module generates reconstructed speech audio using the reconstructed audio features. The audio reconstruction module can include a generator and a discriminator. In some embodiments, the audio reconstruction module is a Mel Generative Adversarial Network (MelGAN) that generates raw audio in the time-domain from the reconstructed audio features in the frequency-domain. In one or more embodiments, a loss between the reconstructed speech audio and the audio sequence received in the training input can be computed and backpropagated as part of training the audio reconstruction module.

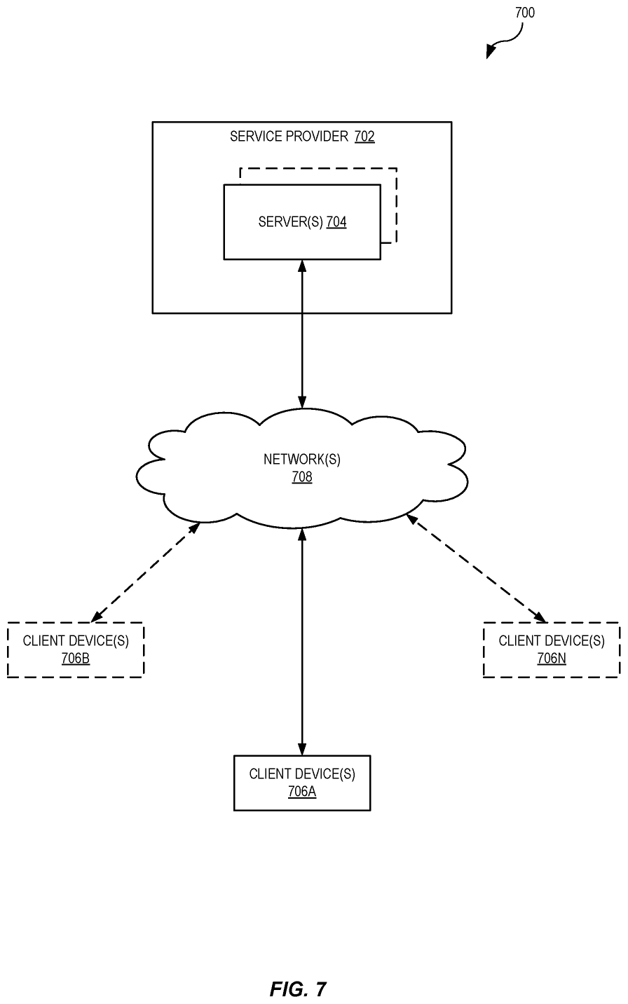

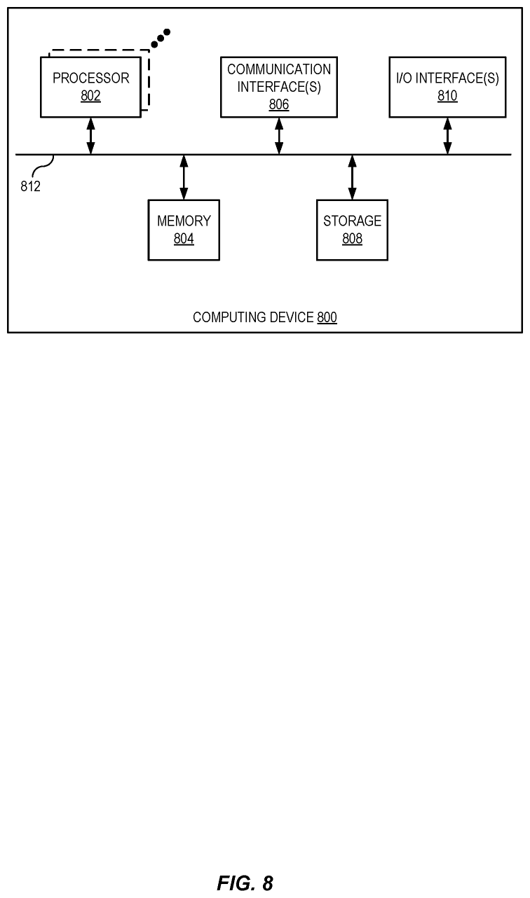

FIG. 7 illustrates a schematic diagram of an exemplary environment 700 in which the audio processing system 500 can operate in accordance with one or more embodiments. In one or more embodiments, the environment 700 includes a service provider 702 which may include one or more servers 704 connected to a plurality of client devices 706A-706N via one or more networks 708. The client devices 706A-706N, the one or more networks 708, the service provider 702, and the one or more servers 704 may communicate with each other or other components using any communication platforms and technologies suitable for transporting data and/or communication signals, including any known communication technologies, devices, media, and protocols supportive of remote data communications, examples of which will be described in more detail below with respect to FIG. 8.

Although FIG. 7 illustrates a particular arrangement of the client devices 706A-706N, the one or more networks 708, the service provider 702, and the one or more servers 704, various additional arrangements are possible. For example, the client devices 706A-706N may directly communicate with the one or more servers 704, bypassing the network 708. Or alternatively, the client devices 706A-706N may directly communicate with each other. The service provider 702 may be a public cloud service provider which owns and operates their own infrastructure in one or more data centers and provides this infrastructure to customers and end users on demand to host applications on the one or more servers 704. The servers may include one or more hardware servers (e.g., hosts), each with its own computing resources (e.g., processors, memory, disk space, networking bandwidth, etc.) which may be securely divided between multiple customers, each of which may host their own applications on the one or more servers 704. In some embodiments, the service provider may be a private cloud provider which maintains cloud infrastructure for a single organization. The one or more servers 704 may similarly include one or more hardware servers, each with its own computing resources, which are divided among applications hosted by the one or more servers for use by members of the organization or their customers.

Similarly, although the environment 700 of FIG. 7 is depicted as having various components, the environment 700 may have additional or alternative components. For example, the environment 700 can be implemented on a single computing device with the audio processing system 500. In particular, the audio processing system 500 may be implemented in whole or in part on the client device 706A. Alternatively, in some embodiments, the environment 700 is implemented in a distributed architecture across multiple computing devices.

As illustrated in FIG. 7, the environment 700 may include client devices 706A-706N. The client devices 706A-706N may comprise any computing device. For example, client devices 706A-706N may comprise one or more personal computers, laptop computers, mobile devices, mobile phones, tablets, special purpose computers, TVs, or other computing devices, including computing devices described below with regard to FIG. 8. Although three client devices are shown in FIG. 7, it will be appreciated that client devices 706A-706N may comprise any number of client devices (greater or smaller than shown).

Moreover, as illustrated in FIG. 7, the client devices 706A-706N and the one or more servers 704 may communicate via one or more networks 708. The one or more networks 708 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 708 may be any suitable network over which the client devices 706A-706N may access the service provider 702 and server 704, or vice versa. The one or more networks 708 will be discussed in more detail below with regard to FIG. 8.

In addition, the environment 700 may also include one or more servers 704. The one or more servers 704 may generate, store, receive, and transmit any type of data, including input data 522, training data 524, and a vector codebook 526 or other information. For example, a server 704 may receive data from a client device, such as the client device 706A, and send the data to another client device, such as the client device 706B and/or 706N. The server 704 can also transmit electronic messages between one or more users of the environment 700. In one example embodiment, the server 704 is a data server. The server 704 can also comprise a communication server or a web-hosting server. Additional details regarding the server 704 will be discussed below with respect to FIG. 8.

As mentioned, in one or more embodiments, the one or more servers 704 can include or implement at least a portion of the audio processing system 500. In particular, the audio processing system 500 can comprise an application running on the one or more servers 704 or a portion of the audio processing system 500 can be downloaded from the one or more servers 704. For example, the audio processing system 500 can include a web hosting application that allows the client devices 706A-706N to interact with content hosted at the one or more servers 704. To illustrate, in one or more embodiments of the environment 700, one or more client devices 706A-706N can access a webpage supported by the one or more servers 704. In particular, the client device 706A can run a web application (e.g., a web browser) to allow a user to access, view, and/or interact with a webpage or website hosted at the one or more servers 704.

Upon the client device 706A accessing a webpage or other web application hosted at the one or more servers 704, in one or more embodiments, the one or more servers 704 can provide a user of the client device 706A with an interface to provide inputs, including an audio sequence. Upon receiving the audio sequence, the one or more servers 704 can automatically perform the methods and processes described above to train an audio processing system to perform high-quality speech audio encoding and decoding using neural networks.

As just described, the audio processing system 500 may be implemented in whole, or in part, by the individual elements 702-708 of the environment 700. It will be appreciated that although certain components of the audio processing system 500 are described in the previous examples with regard to particular elements of the environment 700, various alternative implementations are possible. For instance, in one or more embodiments, the audio processing system 500 is implemented on any of the client devices 706A-706N. Similarly, in one or more embodiments, the audio processing system 500 may be implemented on the one or more servers 704. Moreover, different components and functions of the audio processing system 500 may be implemented separately among client devices 706A-706N, the one or more servers 704, and the network 708.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that one or more computing devices such as the computing device 800 may implement the audio processing system 500. As shown by FIG. 8, the computing device can comprise a processor 802, memory 804, one or more communication interfaces 806, a storage device 808, and one or more input or output (“I/O”) devices/interfaces 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 808 and decode and execute them. In various embodiments, the processor(s) 802 may include one or more central processing units (CPUs), graphics processing units (GPUs), field programmable gate arrays (FPGAs), systems on chip (SoC), or other processor(s) or combinations of processors.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The computing device 800 can further include one or more communication interfaces 806. A communication interface 806 can include hardware, software, or both. The communication interface 806 can provide one or more interfaces for communication (such as, for example, packet-based communication) between the computing device and one or more other computing devices 800 or one or more networks. As an example, and not by way of limitation, communication interface 806 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can comprise hardware, software, or both that couples components of computing device 800 to each other.

The computing device 800 includes a storage device 808 includes storage for storing data or instructions. As an example, and not by way of limitation, storage device 808 can comprise a non-transitory storage medium described above. The storage device 808 may include a hard disk drive (HDD), flash memory, a Universal Serial Bus (USB) drive or a combination these or other storage devices. The computing device 800 also includes one or more I/O devices/interfaces 810, which are provided to allow a user to provide input to (such as user strokes), receive output from, and otherwise transfer data to and from the computing device 800. These I/O devices/interfaces 810 may include a mouse, keypad or a keyboard, a touch screen, camera, optical scanner, network interface, modem, other known I/O devices or a combination of such I/O devices/interfaces 810. The touch screen may be activated with a stylus or a finger.

The I/O devices/interfaces 810 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 810 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A computer-implemented method, comprising:
receiving an audio sequence, the audio sequence including speech audio;
generating pitch data representing detected pitch within the audio sequence;
processing the audio sequence through a convolutional neural network to generate a vector representation of the audio sequence;
generating, by a vector quantizer, an encoded vector representation of the audio sequence using the vector representation of the audio sequence and a codebook of discrete vectors; and
reconstructing the audio sequence using the pitch data and the encoded vector representation of the audio sequence.

2. The computer-implemented method of claim 1, wherein processing the audio sequence through the convolutional neural network to generate the vector representation of the audio sequence comprises:
providing the audio sequence in a raw form to a convolutional neural network.

3. The computer-implemented method of claim 1, wherein processing the audio sequence through the convolutional neural network to generate the vector representation of the audio sequence comprises:
generating audio feature vectors representing the audio sequence using a mel extractor; and
providing the audio feature vectors representing the audio sequence to a convolutional neural network.

4. The computer-implemented method of claim 1, further comprising:
downsampling the vector representation of the audio sequence.

5. The computer-implemented method of claim 1, wherein reconstructing the audio sequence using the pitch data and the encoded vector representation of the audio sequence comprises:
receiving, by an audio decoder, the pitch data, wherein the audio decoder is a recurrent neural network;
generating reconstructed audio feature vectors representing the audio sequence using the pitch data and the encoded vector representation of the audio sequence; and
generating the reconstructed audio sequence by passing the reconstructed audio feature vectors through a neural network.

6. The computer-implemented method of claim 1, wherein generating the pitch data representing the detected pitch within the audio sequence comprises:
extracting initial pitch data from the audio sequence; and
downsampling the initial pitch data to generate the pitch data representing the detected pitch within the audio sequence.

7. The computer-implemented method of claim 1, wherein generating the encoded vector representation of the audio sequence using the vector representation of the audio sequence and the codebook of discrete vectors comprises:
for each audio feature vector of the vector representation of the audio sequence, selecting a coding vector from the codebook of discrete vectors.

8. The computer-implemented method of claim 1, wherein each vector of the codebook of discrete vectors represents a phoneme.

9. A non-transitory computer-readable storage medium storing executable instructions, which when executed by a processing device, cause the processing device to perform operations comprising:
receiving an audio sequence, the audio sequence including speech audio;
generating pitch data representing detected pitch within the audio sequence;
processing the audio sequence through a convolutional neural network to generate a vector representation of the audio sequence;
generating, by a vector quantizer, an encoded vector representation of the audio sequence using the vector representation of the audio sequence and a codebook of discrete vectors; and
reconstructing the audio sequence using the pitch data and the encoded vector representation of the audio sequence.

10. The non-transitory computer-readable storage medium of claim 9, wherein to process the audio sequence through the convolutional neural network to generate the vector representation of the audio sequence the instructions further cause the processing device to perform operations comprising:
providing the audio sequence in a raw form to a convolutional neural network.

11. The non-transitory computer-readable storage medium of claim 9, wherein to process the audio sequence through the convolutional neural network to generate the vector representation of the audio sequence the instructions further cause the processing device to perform operations comprising:
generating audio feature vectors representing the audio sequence using a mel extractor; and
providing the audio feature vectors representing the audio sequence to a convolutional neural network.

12. The non-transitory computer-readable storage medium of claim 9, wherein the instructions further cause the processing device to perform operations comprising:
downsampling the vector representation of the audio sequence.

13. The non-transitory computer-readable storage medium of claim 9, wherein to reconstruct the audio sequence using the pitch data and the encoded vector representation of the audio sequence the instructions further cause the processing device to perform operations comprising:
receiving, by an audio decoder, the pitch data, wherein the audio decoder is a recurrent neural network;
generating reconstructed audio feature vectors representing the audio sequence using the pitch data and the encoded vector representation of the audio sequence; and
generating the reconstructed audio sequence by passing the reconstructed audio feature vectors through a neural network.

14. The non-transitory computer-readable storage medium of claim 9, wherein to generate the pitch data representing the detected pitch within the audio sequence the instructions further cause the processing device to perform operations comprising:
extracting initial pitch data from the audio sequence; and
downsampling the initial pitch data to generate the pitch data representing the detected pitch within the audio sequence.

15. The non-transitory computer-readable storage medium of claim 9, wherein to generate the encoded vector representation of the audio sequence using the vector representation of the audio sequence and the codebook of discrete vectors the instructions further cause the processing device to perform operations comprising:
for each audio feature vector of the vector representation of the audio sequence, selecting a coding vector from the codebook of discrete vectors.

16. The non-transitory computer-readable storage medium of claim 9, wherein each vector of the codebook of discrete vectors represents a phoneme.

17. A system comprising:
a memory component; and
a processing device coupled to the memory component, the processing device to perform operations comprising:
receiving an audio sequence, the audio sequence including speech audio;
generating pitch data representing detected pitch within the audio sequence;
processing the audio sequence through a convolutional neural network to generate a vector representation of the audio sequence;
generating, by a vector quantizer, an encoded vector representation of the audio sequence using the vector representation of the audio sequence and a codebook of discrete vectors; and
reconstructing the audio sequence using the pitch data and the encoded vector representation of the audio sequence.

18. The system of claim 17, wherein to process the audio sequence through the convolutional neural network to generate the vector representation of the audio sequence the processing device further performs operations comprising:
generating audio feature vectors representing the audio sequence using a mel extractor; and
providing the audio feature vectors representing the audio sequence to a convolutional neural network.

19. The system of claim 17, wherein to reconstruct the audio sequence using the pitch data and the encoded vector representation of the audio sequence the processing device further performs operations comprising:
receiving, by an audio decoder, the pitch data, wherein the audio decoder is a recurrent neural network;
generating reconstructed audio feature vectors representing the audio sequence using the pitch data and the encoded vector representation of the audio sequence; and
generating the reconstructed audio sequence by passing the reconstructed audio feature vectors through a neural network.

20. The system of claim 17, wherein to generate the pitch data representing the detected pitch within the audio sequence the processing device further performs operations comprising:
extracting initial pitch data from the audio sequence; and
downsampling the initial pitch data to generate the pitch data representing the detected pitch within the audio sequence.
